(19) United States
(12) Patent Application Publication
(10) Pub. No.: US 2013/0091353 A1
(43) Pub. Date: Apr. 11, 2013

(54) APPARATUS AND METHOD FOR SECURE COMMUNICATION

(71) Applicants: Jiang Zhang, San Diego, CA (US); Alexander Medvinsky, San Diego, CA (US); Kwan Chen, San Diego, CA (US); Paul Moroney, La Jolla, CA (US); Petr Peterka, San Diego, CA (US)

(72) Inventors: Jiang Zhang, San Diego, CA (US); Alexander Medvinsky, San Diego, CA (US); Kwan Chen, San Diego, CA (US); Paul Moroney, La Jolla, CA (US); Petr Peterka, San Diego, CA (US)

(73) Assignee: GENERAL INSTRUMENT CORPORATION, Horsham, PA (US)

(21) Appl. No.: 13/564,643

(22) Filed: Aug. 1, 2012

Related U.S. Application Data
(60) Provisional application No. 61/514,016, filed on Aug. 1, 2011.

(51) Int. Cl. H04L 9/32; H04L 9/08

(52) U.S. Cl. CPC H04L 9/3268; H04L 9/083
USPC 713/156

(57) ABSTRACT

A method and apparatus are for transferring a client device certificate and an associated encrypted client private key to a client device from a secure device. The secure device receives over a secure connection, a secure device certificate, a secure device private key and a plurality of client device certificates. Each client certificate is associated with a bootstrap public key but is not assigned to any particular client device. A plurality of encrypted client private keys is also received. Each of the encrypted client private keys comprises a client private key associated with one of the client device certificates encrypted with the bootstrap public key. The plurality of client device certificates is stored. The encrypted client private keys are stored in double encrypted protected form. A client device certificate and an associated encrypted client private key are transferred to a client device that has successfully registered with the secure device.

### PRIORITY

This application claims priority to U.S. Provisional Patent Application No. 61/514,016 filed on Aug. 1, 2011, “Method of Securing Certificate Download and Protecting the Private Key.”

### FIELD OF THE INVENTION

The present invention relates generally to secure digital communication, and more specifically, to providing a client certificate and associated private key to a client device.

### BACKGROUND

In order to communicate securely between client devices and a network, a secure architecture is commonly used in which the client device stores a client certificate and an associated private key. Currently a certificate and its private key can be loaded into the client device within a secured environment or an environment that is considered secure. For example, for client set-top boxes, which are considered secure devices, the private key and certificate are loaded in the factory using a secure server protocol and protected using a one time programming key. Since the set-top box has a secure boot as well as other hardware security features, only authorized set-top box applications can run on the set-top box to access the private key. This kind of secure device has an anti-debug feature built in, so the private key is securely protected.

However, this kind of secure device requires that the keys are loaded in a secure environment such as the factory and also require that the program execution environment has a secure authentication for programs, with debugging capability disabled. For many consumer electronic devices, such as cellular client devices, there may not be any built-in security features like secure boot and anti-debug, or the built-in security system may be broken. Furthermore, the company that is providing a secure application for such electronic devices may not have any control over their manufacturing process and yet there is a need to install keys and digital certificates in order for that secure application to be fully functional.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments. The description is meant to be taken in conjunction with the accompanying drawings in which:

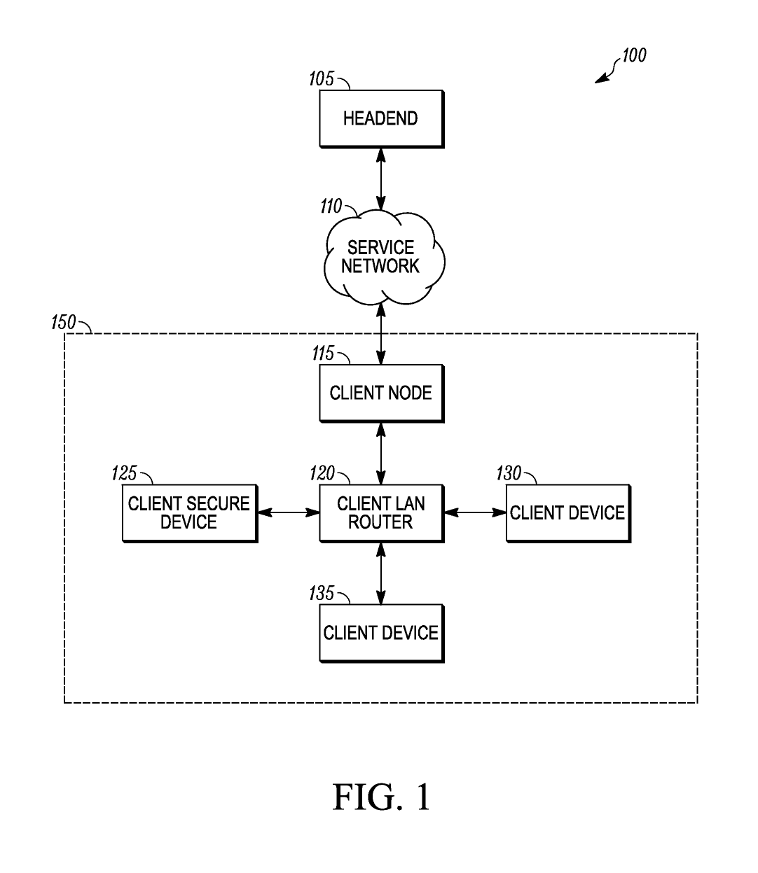

Referring to FIG. 1, a block diagram of a communication system is shown, in accordance with certain embodiments.

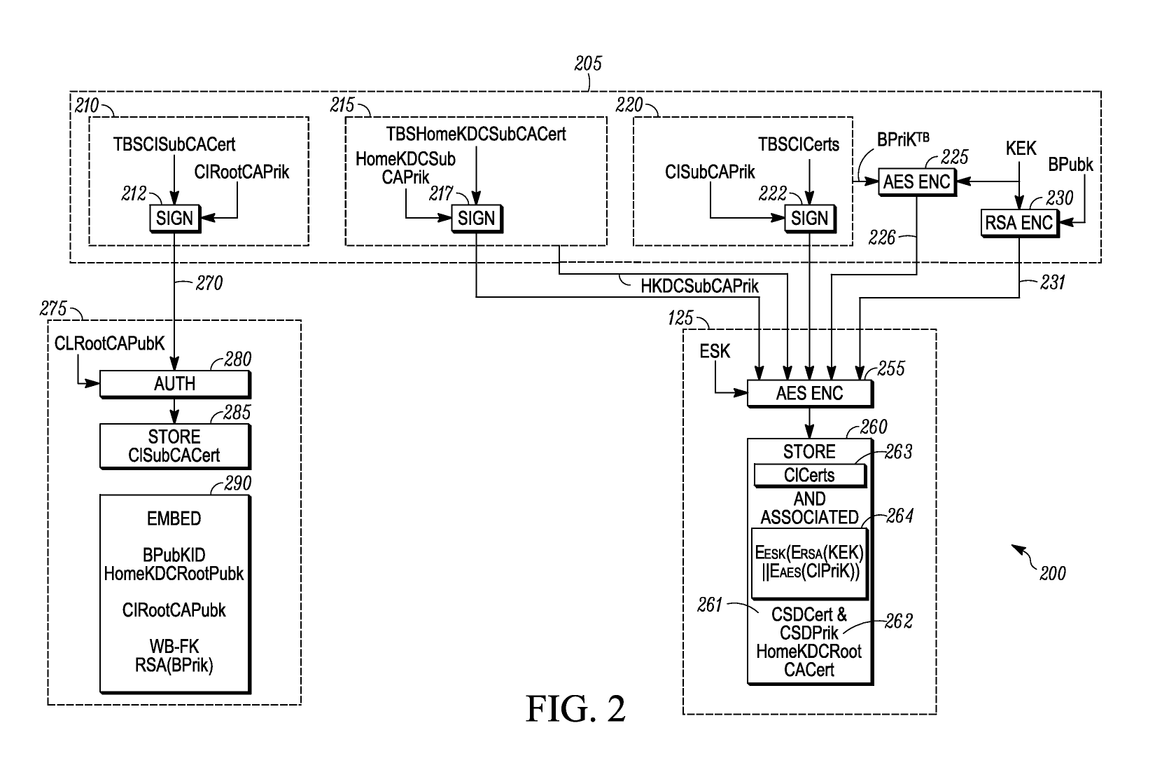

Referring to FIG. 2, an operational block diagram shows portions of a certificate provisioning system and some operations performed therein for certificate provisioning of a client device that may be a non-secure device in accordance with certain embodiments.

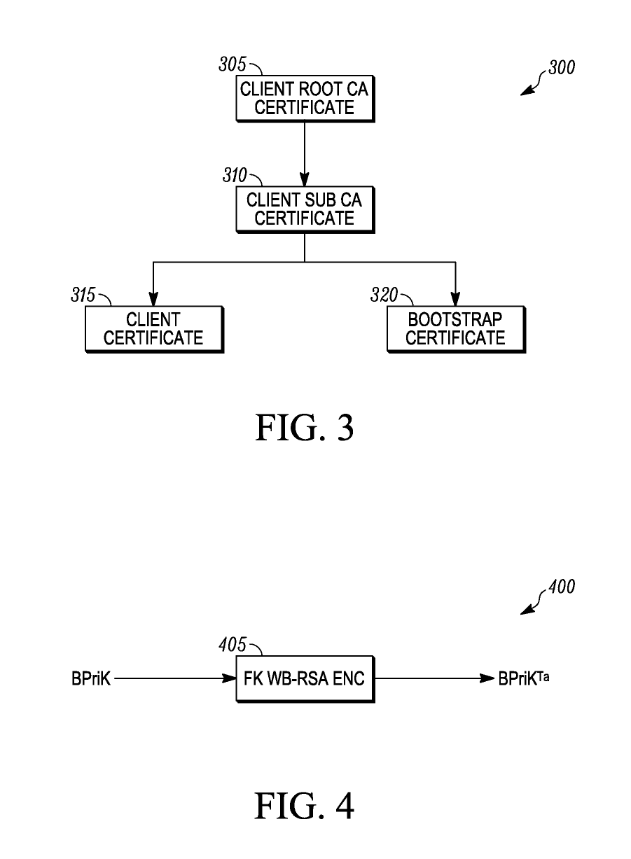

Referring to FIG. 3, a related block diagram shows a multi-layer certificate authority architecture that is used in accordance with the embodiments described with reference to FIG. 2.

Referring to FIG. 4, a functional block diagram shows a function transforming a Bootstrap Private key, in accordance with certain embodiments.

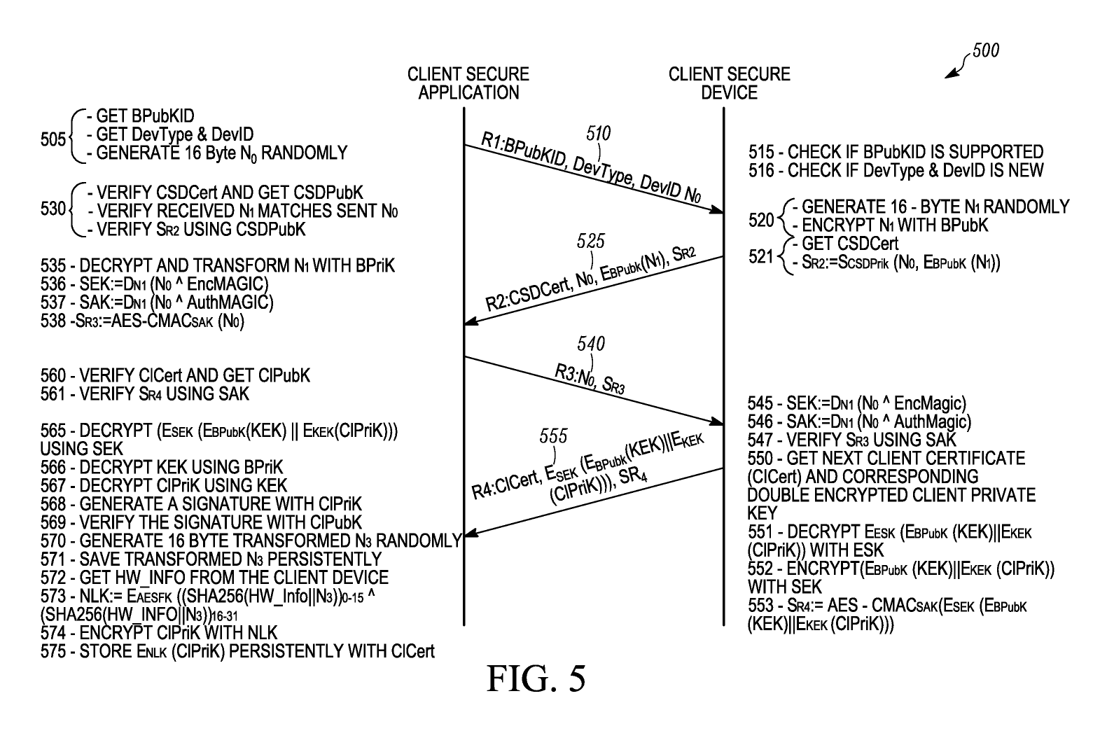

Referring to FIG. 5, a flow diagram shows a method of provisioning the client device with the client certificate and the associated client private key, in accordance with certain embodiments.

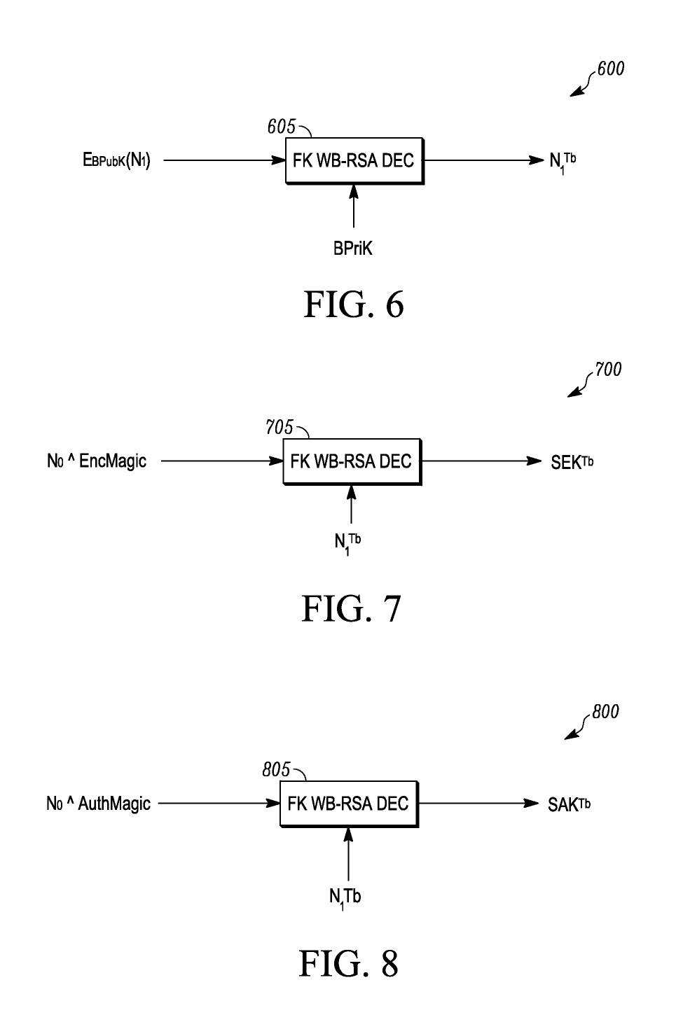

Referring to FIGS. 6-18 are functional block diagrams, each of which shows an operation described with one step of FIG. 5

Referring to FIG. 19, a block diagram shows a client device that is a secure device, in accordance with certain embodiments.

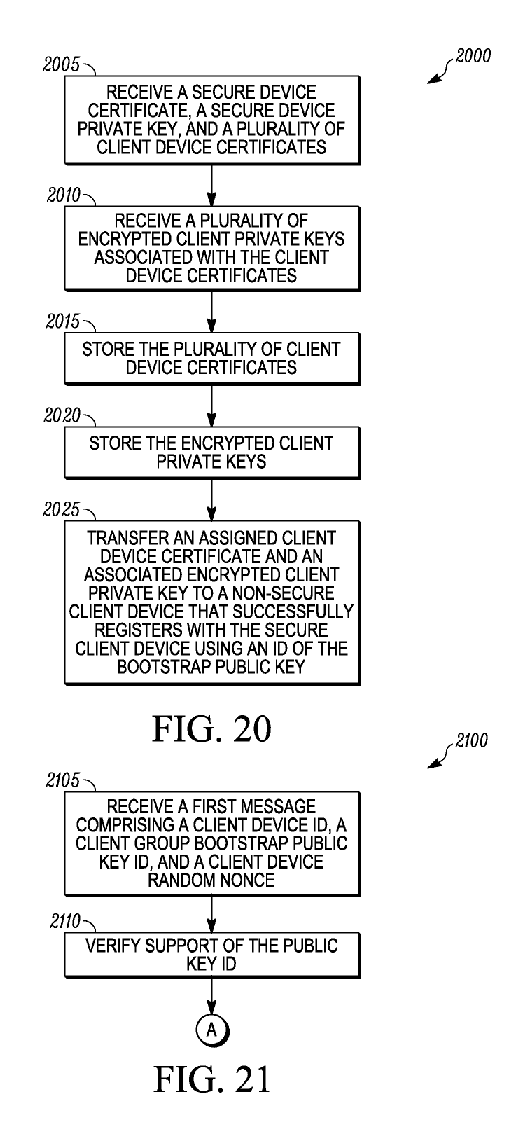

Referring to FIG. 20, a flow chart shows some steps of a method used in client device that is a secure device, in accordance with certain embodiments.

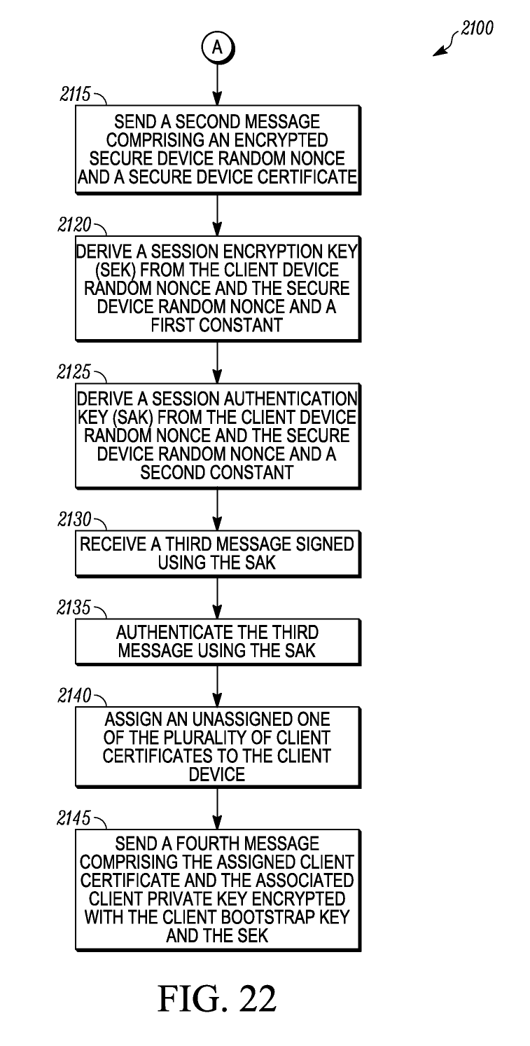

Referring to FIGS. 21 and 22, a flow chart shows some steps of a method used in the secure device described with reference to FIG. 20, in accordance with certain embodiments.

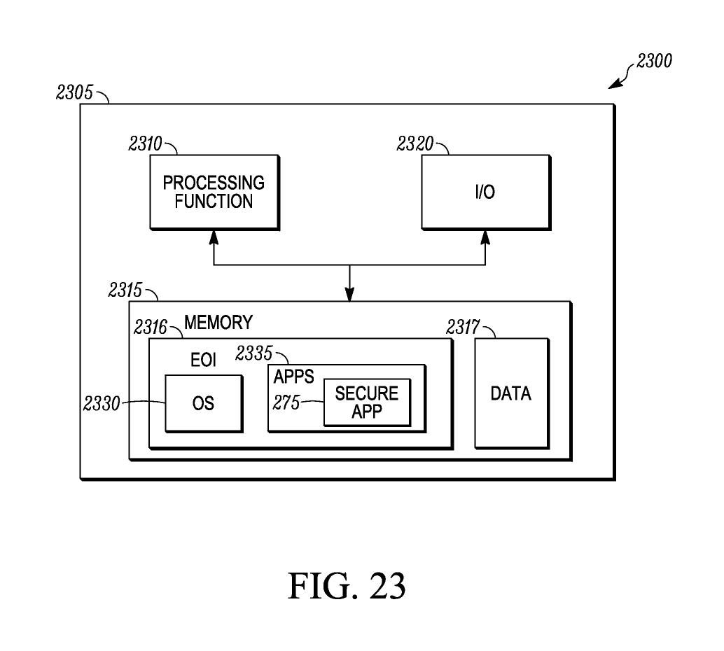

Referring to FIG. 23, a block diagram shows a client device, in accordance with certain embodiments.

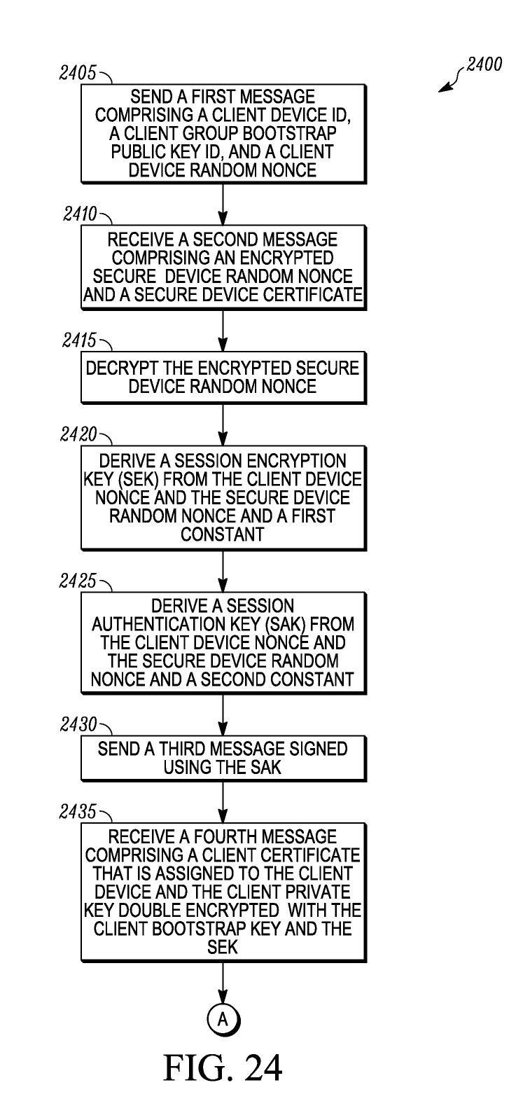

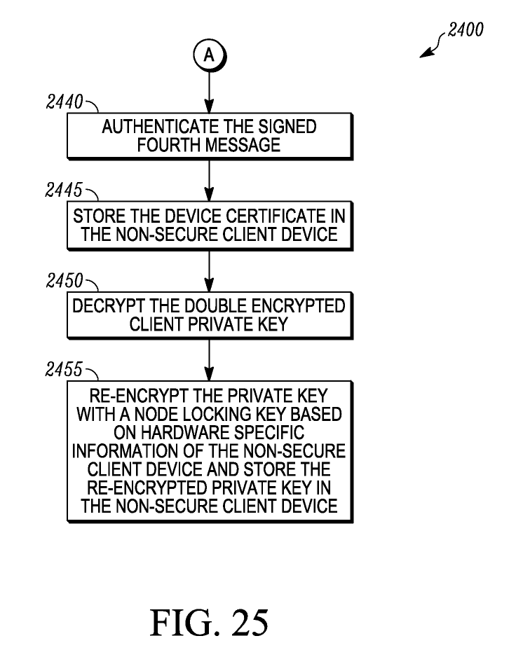

Referring to FIGS. 24 and 25, a flow chart shows some steps of a method used in a secure application running in a client device that is a non-secure device, in accordance with certain embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the embodiments.

### DETAILED DESCRIPTION

In the description below, like reference numerals are used to describe the same, similar or corresponding parts in the several views of the drawings.

Embodiments described herein generally relate to authenticating a client device that may not be deemed to be a secure device. A non-secure client device is provisioned with a client application that is deemed to be a secure client application because of information embedded within the secure client application that is not accessible using techniques that are practical for a almost all clients and because of the operation of the secure client application in conjunction with a client device that is deemed secure. A key is embedded in the secure client application in encrypted form using an obfuscation technique and the key is used to decrypt a client private key using a white box technique. The private key is delivered in double encrypted form through a client device that is a secure device. Unique techniques are used in the client secure application of the non-secure client device. The client secure device also delivers a client certificate that is unique to the client device and provides the public key that is paired to the client private key.

Referring to FIG. 1, a block diagram of a communication system 100 is shown, in accordance with certain embodiments. The communication system 100 comprises a headend 105, a service network 110, and a client local area network (LAN) 150. The communications may be voice, images, or video. The headend 105 may be, for example, a service provider in systems referred to as broadcast systems, such as a cable or satellite service provider (which these days are not restricted to broadcasting but also provide a variety of two way communications). The headend 105 sends communications through the service network 110 to the LAN 150. The client LAN 150 comprises a client node 115, a local area network (LAN) router 120, a client secure device 125, and a plurality of client devices, of which client device 130 and client device 135 are shown in FIG. 1. The client node 115 in a broadcast system may be a set-top box or set-top box/digital video router box, which are secure devices that, among other things, demodulate a channel carrying a digital signal from a radio frequency signal carrying a plurality of such channels and support secure communication between the headend 105 and the client node 115. A secure device, as used in this document, may mean a device that provides hardware security for data (such as a decryption key) stored therein. For example, it is impractical to alter data that has been stored in secure hardware of the secure device, or it is impractical to obtain data that has been stored in the secure hardware of the secure device without using a key uniquely associated with the secure hardware. The client node 115 may be coupled to a LAN router 120, which in a broadcast system may be a home WiFi router, which may provide communications to one or more client devices. In a broadcast system, the client devices (such as client devices 130, 135) may include such devices as TV's, CD players/recorders, DVD players/recorders, and wireless personal communication devices, such as cellular telephones, personal computers, and communication pads that include WiFi. In accordance with certain embodiments, the client device 130 is a device that is not considered secure when it is operated in the client LAN 150 using conventional applications but provides security when using a secure client application as described further herein, after being provisioned by a client secure device 125 as described further herein. The client secure device 125 performs certificate management services for the client devices of the client LAN 150 that need such services, which in the example described further herein includes client device 130. The client secure device 125 may be a stand-alone device such as a digital video recorder or may be combined or incorporated into another device such as a set top box. For example, it could be incorporated into the client node 115. Alternatively, the headend 105 may be a combination of network devices in a system referred to as a two way radio communication system, such as a cellular system. In an embodiment of such a system, a cellular device that is deemed to be a secure device and supports secure communication between the cellular device and the headend may perform as the client node 115 of the communication system 100 and may be coupled by WiFi to a client LAN router 120. Client LAN router 120 may also be incorporated into the client secure device 125. The client devices 130, 135 in such a system may include those devices described herein above with reference to the embodiment of the broadcast communication system. The client secure device 125 in a two way radio communication system embodiment provides the functions described herein below.

At least some of the communications sent from the headend 105 are intended to be available only to certain client devices, such as communications that include digital rights managed communications. In certain embodiments, such rights are protected using a protocol called Internet Protocol Rights Management (IPRM), which is described in U.S. Patent Publication 20060242069, published on Oct. 26, 2006, entitled “Digital rights management for local recording and home network distribution”. Accordingly, the client node 115 that is to receive such communications must be securely authenticated. In certain embodiments the client node 115 is a set-top box/DVR that receives TV programming streams from the service provider's headend 105 and records the streams locally in the DVR portion of the set-top box.

The client secure device 125 communicates with client node 115 to download the recorded content. It then transcodes the content into a resolution and format that is appropriate for client device consumption and stores the transcoded content persistently with IPRM protection.

The client device, such as a mobile phone, communicates with the client secure device to download the transcoded and encrypted content and stores it in its local storage. Alternatively, the client device may not be fully trusted to store high value content and may be allowed only to render the content received from the client secure device, without recording it.

The content delivered from the headend is protected by the service provider's protection scheme. When the client node 115 records and stores the content, it does so using a service provider based protection mechanism. Content transferred from the client node 115 to the client secure device 125 is protected by a content protection protocol such as the DTCP-IP (digital transmission content protection-internet protocol) or DVR2Go™ (Comcast) protocol. IPRM re-encrypts the content before the content is stored in the client secure device 125. The client secure device 125 can then transfer the encrypted content to the client device, where it stays encrypted until playback time, if the client device is authenticated. Alternatively, the content is immediately rendered by the client device and is not persistently saved there.

Services such as transferring content to the client device 130 are not provided unless the client device is provisioned with a digital certificate. Installation of the digital certificate is not always feasible in a secure environment, which for a cellular telephone may only be the factory in which it is manufactured. Embodiments described herein provide a technique to securely download a client certificate to a secure client application running in a non-secure device. Three aspects related to securely downloading a client certificate to a client device 130 are as follows. Firstly, a client secure application having certain characteristics is authenticated to the client secure device 125 prior to downloading the client certificate from the client secure device 125 to the client device 130. Secondly, the private key associated with the client certificate is securely transferred to the client device 130. Thirdly, the private key is securely protected in the client device 130.

Certificate Hierarchy

Referring to FIG. 2, an operational block diagram shows portions of a certificate provisioning system 200 and some operations performed therein for certificate provisioning of a client device 130 (FIG. 1) that may be a non-secure device in accordance with certain embodiments. Operations are shown in FIG. 2 that pertain to the initial provisioning of the client secure device 125 and the client device 130. The certificate provisioning system 200 comprises a public key infrastructure (PKI) 205, which in certain embodiments may be utilized for authentication within IPRM protocols, and a client secure device 125, and a client secure application 275 that is executed in a client device such as client device 130 (FIG. 1).

An unsigned (that is, a to-be-signed [TBS]) Client Sub CA certificate (TBSClSubCert) is signed 212 by a Client Root CA Private Key (ClRootCAPriK). (CA stands for certificate authority.) The Client Sub CA private key (ClSubCAPriK) of the public key pair associated with the Client Sub CA certificate is used by the PKI 205 to sign client certificates (TBSClCerts) that will be used by a group of client devices such as client devices 130, 135 and others that share a common Bootstrap public key pair. This group may be, for example client devices that are to be used within a communication system operated by one operator. At an appropriate time a Client Sub CA certificate 270 is downloaded to each client device that will later be provisioned in accordance with the embodiments described herein. The downloading need not be performed using secure connection. The client device authenticates 280 the signed certificate and if authentication is successful, the Client Sub CA Certificate (ClSubCACert) is stored 285 in a client device memory, which may be persistent but may not be secure. The authentication 280 uses a Client Root Public CA key (ClRootCAPubK) that is embedded 290 in the client secure application 275 at the time of the compiling of the client secure application, although it is possible that other techniques may be used to put the value into the client secure application 275 (such as using an known location in a loadable version of the client secure application after it is compiled). “Embedding” in the context of this document means that a value, which in this case is the Client Root Public CA key, is compiled or otherwise stored within the programmed instructions of the client secure application, as for example, a defined constant, rather than being stored in the client device in locations not used for the client secure application 275. The embedding takes place in a secure environment, such as a secure factory site that is manufacturing or distributing client devices for an operator of the communication system 100 or clients thereof. The client secure application 275 need not be downloaded into the client device within a secure environment (but it must be authenticated as described herein below when it requests a client certificate and private key). This is a benefit of the embodiments described herein.

Referring to FIG. 3, a related block diagram shows a multi-layer certificate authority architecture 300 that is used in accordance with the embodiments described with reference to FIG. 2. Other architectures could be used for embodiments similar to those described herein. A unique Client certificate 315 that is used by each client device in the group and a Bootstrap certificate used by each of the group of client devices in the group is issued under the authority that issues the Client Sub CA certificate 310, which in turn is issued by the authority that issues the Client Root Certificate 305. In the embodiments described with reference to FIGS. 2 and 3 the IPRM protocol is used, but other protocols could be used. The signing of the Client Sub CA certificate and the Client certificates is performed in a secure environment (e.g., within one or more secure servers) that operate within the PKI environment.

Bootstrap Certificate

The Bootstrap certificate is issued by the Client Sub CA and signed by the Client Sub CA Private key (Not explicitly shown in FIG. 2). The Client Sub CA which issues the Bootstrap certificate may be a different Client Sub CA from the one which issues Client certificates. The Bootstrap Public key pair is used for client device application authentication before a unique client certificate and private key are permitted to be installed from a client secure device within the client LAN 150. The Bootstrap Public key is downloaded into the client secure device 125 in a secure environment (i.e., the connection is a secure connection), which may be performed at the location of a PKI secure server (for example a factory manufacturing client secure devices that are for use by clients of the operator of the communication system 100). The Bootstrap Private key is further processed in a secure environment with a software tool such as the Cloakware technology product wbdatagen that is distributed by Irdeto of San Francisco, Calif., USA which obfuscates the Bootstrap Private key. The obfuscated Bootstrap Public key is then embedded 290 into the client secure application 275 during the build process of the client application and eventually is loaded into a client device via download of the client secure application 275. The Cloakware technology product wbdatagen is one example of an obfuscation tool that generates data objects or software that cannot be taken advantage of by any 3^{rd} party software without the presence of the obfuscation software. This obfuscation of the Bootstrap Private key is an example of a fixed key white box RSA (FK WB-RSA) transformation function. Referring to FIG. 4, a functional block diagram 400 shows the FK WB-RSA function 405 transforming the Bootstrap Private key BPriK to a value identified as BPriK^{Ta} for embedding into the client secure application, in accordance with certain embodiments. The Bootstrap Public key has an identification value (BPubKID) that is also embedded into the client secure application.

Client Certificate

Referring back to FIG. 2, Client certificates are issued by the Client Sub CA 220 and are to be used by the client device for authentication purposes. The private exponent of the Client Private key (ClPriK) for each client certificate is AES (Advanced Encryption Standard) encrypted (AES ENC) 225 using a random 128-bit AES key with AES CBC mode and IV=0. Note, here only the private exponent d is encrypted, since the modulus can be found in the public key from the certificate. The random AES key (KEK) is unique for each Client Private key. The KEK is RSA encrypted 230 using the Bootstrap Public Key in a secure environment such as a PKI center. The encrypted ClPriK 226 and encrypted KEK 231 for each Client certificate are downloaded into the client secure device 125 in a secure environment. In the client secure device 125, the encrypted ClPriK 226 and encrypted KEK 231 are concatenated and further encrypted (a form of double encrypting) with a secure storage key (ESK) of the client secure device 125, and the double encrypted client private keys 264 are persistently stored. A plurality of the Client certificates 263 is issued in anticipation for use by several client devices within the client LAN 150. The Client certificates (ClCerts) are not associated with particular client devices when they are issued or when they are stored in the client secure device 125. Thus, a plurality of unique Client certificates 263 and associated double encrypted Client Private keys 264 are stored in the client secure device 125. The Client certificates may be encrypted 255 and securely stored 260 by the client secure device 125, as depicted in FIG. 2, but they need not be either encrypted or securely stored.

Home KDC Sub CA Certificate

A TBS Home KDC Sub CA certificate (TBSHomeKDCSubCACert) is signed by a Home KDC Root CA Private key (HomeKDCRootCAPriK). The signed Home KDC Sub CA certificate is authenticated (not shown in FIG. 2) by the client secure device 125 using the Home KDC Root CA Public key. The Home KDC Sub CA certificate is shown as being encrypted 255 by the SEK and securely stored 260 in the client secure device 125, but it need not be either encrypted or securely stored.

Client Secure Device Certificate

The Client Secure Device certificate (CSDCert) 261 is issued by the Home KDC Sub CA (not shown in FIG. 2) and downloaded to the client secure device 125 in a secure environment. The associated Client Secure Device Private key (CSDPriK) 262 is downloaded to the client secure device 125 in a secure environment where it is AES encrypted 255 by the SEK and securely stored 260 and thereafter used by the client secure device 125 to sign secure protocol messages exchanged with client devices. The Client Secure Device certificate is authenticated (not shown in FIG. 2) by the client devices 130 and 135 using the Home KDC Sub CA Public key. The Client Secure Device certificate is shown as being encrypted 255 by the SEK and securely stored 260 in the client secure device, but it need not be either encrypted or securely stored.

Certificate Download to Client Device with Two-way Authentication

When a cellular telephone or other client device communicates with the client secure device 125 and requests the certificate and the private key, a two-way authentication is conducted so as to prevent the client secure device 125 from giving the client certificate and the client private key to a rogue client device and to prevent the client device from getting content from illegitimate entities. The two way authentication is detailed below in three sections: preconditions, trigger, and steps.

Preconditions to Certificate Download to Client Device

The following preconditions have been detailed above in the paragraphs of the certificate hierarchy and provisioning operation: The obfuscated Bootstrap Private key, the Home KDC Root CA Public key, the Bootstrap Public key identification, and the Client Root CA Public key are embedded 290 (FIG. 2) in the client secure application 275. The Client Device certificates and the associated double encrypted Client Private keys, the Client Secure Device certificate and its corresponding private key, and the Home KDC Sub CA certificate are stored in the client secure device 125 in a secure environment. As Cloakware technology doesn't support CRT format private key, it's enough to only encrypt the private exponent here.

Trigger for Certificate Download to Client Device

The process to provision the client device with the client certificate and associated client private key is triggered when the client secure application is opened and determines that it does not have the client certificate and associated client private key.

Method of Certificate Download to Client Device with two way Authentication

Referring to FIG. 5, a flow diagram 500 shows a method of provisioning the client device with the client certificate and the associated client private key, in accordance with certain embodiments. The steps performed by the client device 130 are performed by the client secure application 275 of the client device.

At step 505, the client secure application 275 running on the client device 130 generates a 16-byte random number N₀, and retrieves the Bootstrap Public Key ID (BPubKID), its Device Type (DevType), and its Device ID (DevID) and uses them to compose a Session Key Request message R1. The client device 130 sends R1 to the client secure device 125 at step 510. The BPubKID is an ID for the BPubK. If a list of BPubKs is supported by the client secure application 275, the client secure application 275 will try a most preferred BPubKID first.

At step 515, the client secure device 125 receives message R1 and checks whether the BPubKID is supported. If not, the client secure device 125 returns an error to the client device 130 indicating that the BPubKID is not supported. (Not shown in FIG. 5.) If the client secure device 125 returns an error to the client device that the BPubKID is not supported, the client secure application 275 will keep trying others in the list until a supported one is found. (Not shown in FIG. 5.) If none of the BPubKID's is supported, the client secure device 125 stops and reports an error. (Not shown in FIG. 5.) If the BPubKID is supported, the client secure device 125 saves the Device Type and Device ID in memory.

At step 516, the DevType and DevID may be used by client secure device 125 to identify whether this request is an attempt to re-download a client certificate by a client device 130 that has previously downloaded a client certificate. The same client device is allowed to re-download a client certificate, if the client secure application 275 has been removed and re-installed in the client device 130. However, if a new certificate is successfully downloaded to the same client device, the previous certificate is revoked on the client secure device 125. This helps to de-register a client device if the client forgets to de-register the client device when the client secure application is removed.

At step 520, the client secure device 125 generates a random number N₁ and RSA encrypts N₁ with BPubK using a PKCS#1 v1.5 encryption algorithm. The client secure device 125 at step 521 gets its Client Secure Device certificate (CSDCert), generates a signature S_{R2} over N₀ and the encrypted N₁ using its private key CSDPriK and at step 525 sends a signed Session Key Reply message R2 to the client device 130. Message R2 includes Client Secure Device certificate, N₀, encrypted N₁ and the signature S_{R2}.

At step 530, the client secure application 275 verifies the client secure device certificate chain using Home KDC Root CA Public Key that has been embedded in the client secure application 275 and extracts the Client Secure Device's public key CSDPubK from the certificate if the certificate is verified. Since the RSA signature verification doesn't involve any secret key or data, the signature verification function doesn't need to be obfuscated. The client secure application 275 verifies that the received N₀ matches the one sent out and verifies the signature S_{R2} using the CSDPubK, which authenticates the client secure device 125 as a trusted device. If authentication succeeds, the method continues with the next step, otherwise the method goes into an exception mode.

At step 535 the client secure application 275 invokes a Fixed Key White Box RSA decode function (FK WB-RSA) to decrypt the encrypted value N1 using the transformed Bootstrap private key BPriKTa. The FK-WB-RSA decrypt function results in a transform of the N1, which is designated N1Tb. Note that as a result of steps 520, 525, and 535, the untransformed value of N1 not exposed in the client device 130. Referring to FIG. 6, a functional block diagram 600 shows this decoding and transform function FK WB-RSA DEC 605, in accordance with certain embodiments.

At step 536 (FIG. 5) the client secure application 275 XOR-es N0 and a number (EncMagic) used to generate session encryption keys. EncMagic is a defined constant. A transformed Session Encryption Key (SEKTb) is generated using a White Box AES Decryption function (WB-AES DEC) having the transformed N1 (N1Tb) as the key. The client secure application saves SEKTb in a memory of the client device 130. This operation is identified in step 536 of FIG. 5 as SEK:=DN1(N0 ̂ EncMagic). Referring to FIG. 7, a functional block diagram 700 shows the WB-AES decode function 705, in accordance with certain embodiments. The XOR-ing is indicated by the symbol “̂”.

At step 537 (FIG. 5) the client secure application 275 XOR-es N0 and a number (AuthMagic) used to generate authentication keys. AuthMagic is another defined constant A transformed Session Authorization Key (SAKTb) is generated using the White Box AES Decryption function (WB-AES DEC) having the transformed N₁ (N₁^{Tb}) as the key and saves SAKTb in a memory of the client device 130. This operation is identified in step 536 of FIG. 5 as SAK:=DN1(N0 ̂ AuthMagic). Referring to FIG. 8, a functional block diagram 800 shows the WB-AES decode function 805, in accordance with certain embodiments. If the signature algorithm used in the next step (step 538) requires a key longer than the 16 bytes of SAKTb, then XOR SAKTb with the AuthMagic and use the result as an input to the WB-AES DEC 805 to generate a next 16 bytes of key data. This is repeated until an expanded SAK having enough key data is generated.

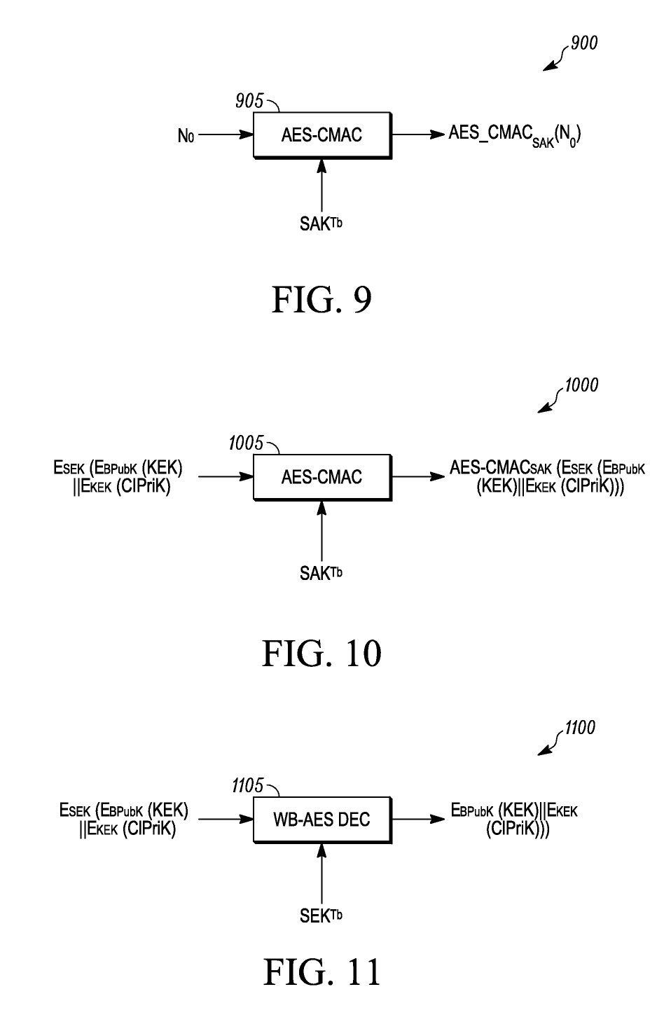

At step 538 (FIG. 5) the client secure application 275 generates symmetric signature SR3 over N0 using the SAKTb or expanded SAKTb generated in step 537 and at step 540 the client device 130 sends a signed Client Certificate Request Message R3 to the client secure device 125. Referring to FIG. 9, a functional block diagram 900 shows the AES-CMAC signature function 905, in accordance with certain embodiments. Other symmetric signature functions could alternatively be used.

Upon receipt of Message R3, the client secure device 125 generates the Session Encryption Key (SEK) and the Session Authentication Key (SAK) at steps 545, 546 (FIG. 5) using the same processes as used by the client secure application 275 in steps 536 and 537.

At step 546 the client secure device 125 generates the Session Authentication Key (SAK) using the same process as used by the client secure application 275 in step 538.

At step 547 the client secure device 125 verifies the signature S_{R3} using SAK. If the signature is verified, it proves that the client secure application 275 has decrypted N₁ using the Bootstrap private key and derived the SAK correctly. This also authenticates the client secure application 275 is a trusted client secure application. If the signature is verified, the method continues with the next step, otherwise the method goes into an exception mode.

At step 550 the client secure device 125 retrieves the next available double encrypted Client Private key and its corresponding certificate CCert from secure storage in the client secure device 125.

At step 551 the client secure device 125 decrypts the outer layer of the double encrypted client private key E_{ESK}(E_{BPubK}(KEK) ∥ E_{KEK}(ClPriK)) using the external storage key ESK of the client secure device 125, decrypting with AES CBC mode and IV=0, and uses the same AES algorithm to re-encrypt it with the SEK to get E_{SEK}(E_{BPubK}(KEK) ∥ E_{KEK}(ClPriK)), which is a double encryption of another form. If there is a short residual block, the last block is encrypted again and the left side bytes of the ciphertext are used to XOR with the residual block.

At step 552 the client secure device 125 generates an AES-CMAC signature over the SEK double encrypted private key using SAK: S_{R4}=AES−CMAC_{SAK}(E_{SEK}(E_{BPK}(KEK) ∥ EKEK(ClPriK))). Other symmetric signature functions could alternatively be used.

At step 553 the client secure device 125 generates a Client Certificate Reply message R4 with the client certificate ClCert, the SEK double encrypted private key and the AES-CMAC signature that was generated in step 553 and sends R4 at step 555 to the client secure application 275. The client secure device 125 marks this set of client certificate and private key with the Client Device ID which indicates that it is in use by the client device 130.

At step 560 the client secure application 275 verifies the client certificate chain using Client Root CA public key that is embedded in the client secure application 275 and extracts the client public key CPubK.

At step 561 the client secure application 275 generates the AES-CMAC over the double encrypted the client private key using SAK in a signature function and verifies whether it matches the received AES-CMAC signature. Referring to FIG. 10, a functional block diagram 1000 shows the AES-CMAC signature function 1005, in accordance with certain embodiments. If both of the verifications in steps 560 and 561 succeed, the method continues with the next step, otherwise the method goes into an exception mode.

At step 565 (FIG. 5) the client secure application 275 decrypts the outer layer of the double encrypted private key using SEK and a Fixed Key White Box AES decryption function to get E_{BPubK}(KEK) ∥ E_{KEK}(ClPriK). Referring to FIG. 11, a functional block diagram 1100 shows the FK WB-AES decryption function 1105, in accordance with certain embodiments.

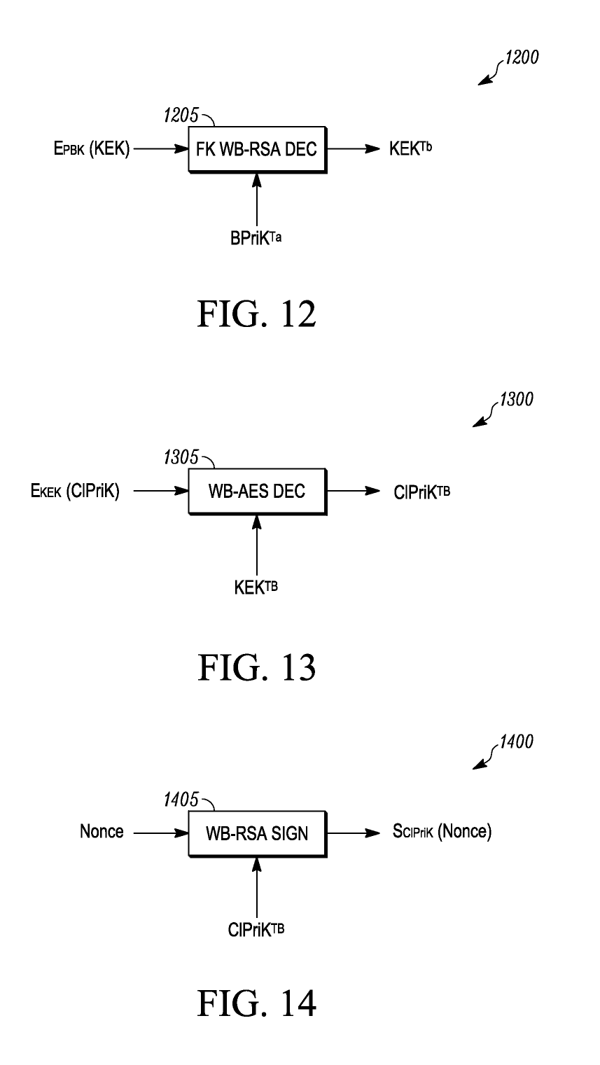

At step 566 (FIG. 5) the client secure application 275 decrypts the encrypted random number key E_{BPriK}(KEK) using the value BPriK^{Ta} that was embedded in the client secure application 275 and a Fixed Key White Box RSA decryption to get KEK^{Tb}, a transformed version of KEK. Referring to FIG. 12, a functional block diagram 1200 shows the FK WB-RSA decryption function 1205, in accordance with certain embodiments.

At step 567 the client secure application 275 decrypts the encrypted client private key (ClPriK) using KEK^{Tb} in a white box AES decryption function (WB-AES DEC) to get a transformed ClPriK^{Tb}. Note that this transformed CPriK^{TB} only contains the private exponent of the private key. The modulus can be retrieved from the client device certificate. The private exponent is encoded with the modulus following a White Box format before being used by the WB-RSA signing function in step 568. Referring to FIG. 13, a functional block diagram 1300 shows the WB-AES decryption function 1305, in accordance with certain embodiments.

At step 568 (FIG. 5) the client secure application 275 generates a random number Nonce, also referred to herein as a random nonce, and generates an RSA signature over the Nonce using the encoded transformed client private key (ClPriK) with PKCS#1 v1.5 algorithm, using a White Box RSA Signing function. Referring to FIG. 14, a functional block diagram 1400 shows the WB-RSA signature function 1405, in accordance with certain embodiments. In some embodiments, data other than random data may be used, such as a text phrase.

At step 569 (FIG. 5) the client secure application 275 verifies the signature using the ClPubK extracted from the client certificate. If verified, it proves that the private key and the certificate are matching, and the method continues with the next step, otherwise the method goes into an exception mode.

At step 570 the client secure application 275 generates a 16 byte transformed random number N₃^{Tc} and at step 571 saves the transformed N₃ persistently. The transform Tc is specifically for N₃ and only used for N₃. At step 572 the client secure application 275 obtains hardware information HW_Info from the client device 130, including for example the Device Type, Device ID, MAC address for WiFi and/or Ethernet, CPU information and other information. This hardware information is platform dependent. For example, for iPhone or iPod Touch, the names of some hardware information are DevType, UDID, WiFi MAC address, and certain processor information.

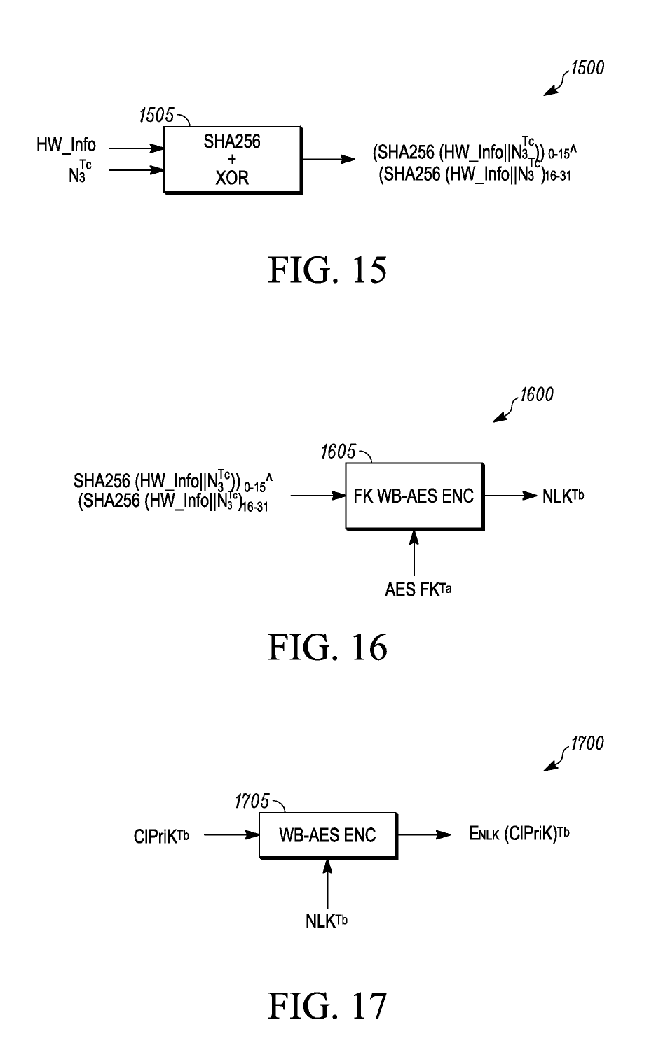

At step 573 the client secure application 275 generates a SHA256 hash over the concatenation of the hardware information and NTc3, and XOR's the first and the second 16 bytes of the hash. Referring to FIG. 15, a functional block diagram 1500 shows the hash function 1505, in accordance with certain embodiments.

At step 574 (FIG. 5) the client secure application 275 uses a Fixed Key WB-AES function to derive a transformed Node-Locking Key (NLK^{Tb}) from the XOR-ed hash value: NLK:=E_{AESFK}((SHA256(HW_Info ∥ N₃))₀₋₁₅ ̂ (SHA256(HW_Info ∥ N₃))₁₆₋₃₁). The NLK^{Tb} is used by the client secure applications 275 as the External Storage Key (ESK) of the client device. Referring to FIG. 16, a functional block diagram 1600 shows the FK WB-AES encryption function 1505, in accordance with certain embodiments.

At step 575 (FIG. 5) the client secure application 275 encrypts the client private key using the NLK, and saves the encrypted client private key persistently with the client certificate. An obfuscated white box encryption algorithm may be used in this case, such as White Box AES-CBC mode. Now the device certificate and client private key have been successfully downloaded. Referring to FIG. 17, a functional block diagram 1700 shows the WB-AES encryption function 1705, in accordance with certain embodiments. Other encryption functions, such as WB-DES or WB-3DES could be used as well.

Use of Private Key by the secure client application

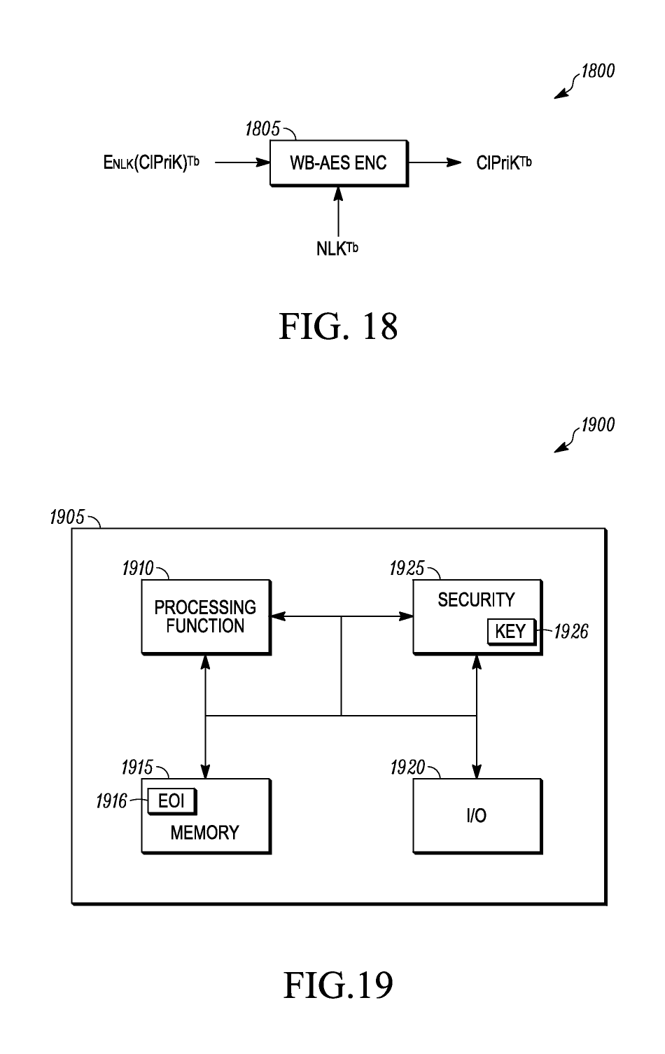

When the client secure application 275 invokes the use of the client private key, the client secure application 275 retrieves the transformed random number N₃ and collects the hardware information HW_Info from the device. The client secure application 275 derives a transformed Node-Locking Key (NLK) the same way as described above. The client secure application 275 retrieves the encrypted client private key and decrypts it with the NLK. Referring to FIG. 18, a functional block diagram 1800 shows the client private key decryption function 1805, in accordance with certain embodiments. The client secure application 275 uses the transformed client private key to sign messages.

Referring to FIG. 19, a block diagram 1900 shows a client device that is a secure device 1905, in accordance with certain embodiments. The client secure device 125 described with reference to FIG. 2 may be the secure device 1905 or may use the architecture described in FIG. 19, but may have a different architecture known in the art that may have persistent and transient memory and a security function that can provide security at least for data stored in the persistent memory. The secure device 1905 includes a processing function 1910 comprising one or more processing devices, each of which may include such sub-functions as central processing units, cache memory, instruction decoders, just to name a few. The processing function 1910 executes program instructions which may be located within memory in the processing devices, or may located in a memory 1915 external to the processing function 1910, to which the memory 1915 is bi-directionally coupled, or in a combination of both. The embodiment in FIG. 19 shows the executable operating instructions (EOI) 1916 being stored in the memory 1915 external to the processing function 1910. The memory 2315 also stores data. The EOI 1916 of the secure device 1905 includes groups of instructions, one of which is an operating system (OS) and others are applications. The combination of the processing function 1910 and the EOI 1916 is also referred to as the processing system of the secure device 1905.

The memory 1915 is herein termed “persistent memory”, which comprises memory that is external to the processing function 1910 and excludes transient memory such as internal cache memory, registers, and processor stacks for which data that is being stored therein cannot be extracted from the client device by techniques that are non-invasive to the integrated circuits of the processing function 1910.

Referring to FIG. 20, a flow chart 2000 shows some steps of a method used in client device that is a secure device, such as client device 1905 or client secure device 125, in accordance with certain embodiments. At step 2005, the secure device receives from a secure server over a secure connection a secure device certificate, a secure device private key, and a plurality of client device certificates. Note that the security of the secure server and secure connection may be achieved by cryptographic techniques or may be achieved by physical restrictions such as having the secure server and secure device coupled to each other in a secure location, such as a secure factory. Each client certificate is not yet assigned to any particular client device. At step 2010 the secure device receives from the secure server over the secure connection a plurality of encrypted client private keys. In some embodiments, the plurality of client device certificates and the plurality of encrypted client private keys are received as a plurality of pairs, each pair comprising a client device certificate and an associated encrypted client private key. Each of the encrypted client private keys comprises a client private key associated with one of the client device certificates where the client private keys are each key encrypted using a bootstrap public key. As used herein “key encrypted using a bootstrap public key” means that each of the encrypted client private keys comprises a concatenation of an encryption of the client private key by a random number uniquely associated with the client private key and an encryption of the random number by the bootstrap public keyIn some embodiments, the encryption of the client private key used in the concatenation is an encryption of only the private exponent of the client private key by the random number. The secure device double encrypts each of the plurality of encrypted client private keys with an external storage key. At step 2015 the secure device persistently stores the plurality of client device certificates. At step 2020 the secure device persistently stores the encrypted client private keys in a protected form, which is a double encrypted form. At step 2025 the secure device assigns a client device certificate and an associated client private key to a client device in which a secure application runs that successfully registers with the secure device using an identification of the bootstrap public key, and transfers the certificate and key to the client device. In some embodiments, the steps described with reference to FIG. 20 correspond to actions described with reference to FIG. 2.

Referring to FIGS. 21 and 22, a flow chart 2100 shows some steps of a method used in the secure device described with reference to FIG. 20, in accordance with certain embodiments. At step 2105 the secure device receives a first message comprising a client device identification, a client group bootstrap public key identification, and a client device random nonce from the secure application running in the non-secure client device. (“Running in” means “being executed by the processing system of”). At step 2110 the secure device verifies that the public key identification is supported by the secure device. At step 2115 the secure device sends a second message to the secure application that comprises an encrypted secure device random nonce and a secure device certificate, wherein the encrypted secure device nonce has been encrypted with a client group bootstrap public key that is identified by the client group bootstrap identification. At step 2120 the secure device derives a session encryption key from the client device random nonce and the secure device random nonce. At step 2125 the secure device derives a session authentication key from the client device random nonce and the secure device random nonce. At step 2130 the secure device receives a third message from the secure application with a symmetric signature computed using the session authentication key. At step 2135 the secure device authenticates the third message using the session authentication key. At step 2140 the secure device retrieves one of the plurality of client certificates and performing external storage key decryption of the associated double encrypted private key and assigning them to the non-secure client device. At step 2145 the secure device sends a fourth message to the secure application comprising the assigned client certificate and the associated encrypted client private key wherein the associated encrypted client private key is a double encrypted client private key that comprises an key-encrypted client private key that has been key-encrypted using the client group bootstrap public key and the resultant key-encrypted private key is encrypted by the session encryption key, and wherein the fourth message is signed with a symmetric signature computed using the session authentication key. As used herein “key-encrypted using a client group bootstrap public key” means that each of the encrypted client private keys comprises a concatenation of an encryption of the client private key by a random number uniquely associated with the client private key and an encryption of the random number by the client group bootstrap public key. In some embodiments, the encryption of the client private key used in the concatenation is an encryption of only the private exponent of the client private key by the random number.

In some embodiments the steps described with reference to FIGS. 21 and 22 correspond to steps described in FIG. 5 as follows:

| FIGS. 21-22 | FIG. 5 |
|---|---|
| 2105 | 510 |
| 2110 | 515 |
| 2115 | 525 |
| 2120 | 545 |
| 2125 | 546 |
| 2130 | 540 |
| 2135 | 547 |
| 2140 | 550 |
| 2145 | 555 |

Referring to FIG. 23, a block diagram 2300 shows a client device 2305, in accordance with certain embodiments. The client device 2305 may be a personal communication device such as a TV, an AM/FM receiver/amplifier, cell phone, a tablet, or a personal computer, or may be any other type of device having a Wi-Fi or other local area connection. The client device 130 (FIG. 1) may use the architecture described in FIG. 23, but may have a different architecture known in the art that has persistent and transient memory and in which the persistent memory stores programmed instructions for a secure application, as well as data. The device 2305 includes a processing function 2310 comprising one or more processing devices, each of which may include such sub-functions as central processing units, cache memory, instruction decoders, just to name a few. The processing function 2310 executes program instructions which may be located within memory in the processing devices, or may located in a memory 2315 external to the processing function 2310, to which the memory 2315 is bi-directionally coupled, or in a combination of both. The embodiments in FIG. 23 show the executable operating instructions (EOI) 2316 being stored in the memory 2315 external to the processing function 2310. The memory 2315 also stores data 2317. The EOI 2316 of the client device 2305 includes groups of instructions identified as an operating system (OS) 2339 and applications 2335. The applications 2335 comprise non-secure applications and at least one secure application (SECURE APP) 275, some aspects of which are described with reference to FIG. 2, as well as other places in this document. The combination of the processing function 2310 and the EOI 2316 is also referred to as the processing system of the client device 2305.

The memory 2315 is herein termed “persistent memory”, which comprises memory that is external to the processing function 2310 and excludes transient memory such as internal cache memory, registers, and processor stacks for which data that is being stored therein cannot be extracted by techniques that are non-invasive to the integrated circuits of the processing function 2310. The processing function 2310 may include input/output (I/O) interface circuitry and may be coupled to separate input/output interface circuitry 2320 that is controlled by the processing function 2310. The client device 2305 I/O 1920 provides for communications to other computing devices, such as servers and other network devices (e.g., the secure device 125), using standard hardware and software protocols.

The client device 2305 is referred to as a non-secure device in some embodiments because it may have no security features to protect information stored in any persistent memory, or it may have security features that been found to be insecure or have been deemed after analysis to be insecure in the sense of preventing an user from gaining unauthorized access to data stored in the device or data that is to be downloaded to the device. Therefore the client device 2305 is referred to as a non-secure device. In accordance with certain embodiments, a secure application 275 has been installed (in the software sense) in the non-secure device 2305, with the program instructions residing in the memory 2316. The secure application 275 has unique aspects described throughout this document. This secure application 275 does not render the client device 2305 as a secure device; rather it renders the functions provided by the secure application 275 to be secure, in spite of the fact that the data stored by the secure application 275 may be insecure. The secure application 275 may be also installed in client devices that are secure and could operate as described herein.

Referring to FIGS. 24 and 25, a flow chart 2400 shows some steps of a method used in a secure application running in a client device that is a non-secure device, such as client device 2305 or client device 130, in accordance with certain embodiments. At step 2405 the secure application sends a first message comprising a client device identification, a client group bootstrap public key identification, and a client device random nonce to another client device that is a secure device. At step 2410 the secure application receives a second message from the secure device that comprises an encrypted secure device random nonce and a secure device certificate, wherein the encrypted secure device nonce has been encrypted with a bootstrap public key identified by the client bootstrap identification. At step 2415 the secure application decrypts the encrypted secure device random nonce using the bootstrap public key and a white box decryption function to produce a transformed secure device random nonce. At step 2420 the secure application derives a session authentication key from the random client device nonce and the transformed secure device random nonce. At step 2425 the secure application derives a session encryption key from the random client device nonce and the transformed secure device random nonce.

At step 2430 the secure application sends a third message to the secure device with a symmetric signature computed using the session authentication key. At step 2435 the secure application receives a fourth message from the secure device comprising the client certificate and a double encrypted client private key that are assigned to the client device, wherein the double encrypted client private key comprises an encrypted client private key that has been encrypted with the client group bootstrap public key and the resultant encrypted client private key is encrypted by the session authentication key and wherein the fourth message is signed with a symmetric signature computed using the session authentication key. At step 2440 the secure application authenticates the signed fourth message using the session authentication key. At step 2445 the secure application stores the device certificate in persistent memory of the non-secure client device. At step 2450 the secure application decrypts the double encrypted client private key using the session key and the bootstrap public key, thereby generating the client private key. At step 2455 the secure applications re-encrypts the private key with a node locking key based on hardware specific information of the client device and persistently storing the re-encrypted private key in persistent memory of the non-secure client device, wherein the secure device random nonce and the client private key are never stored in plain form (without white box transformation) in the memory of the non-secure client device. Note that the secure application would operate the same way if installed in a secure client device, even though it may be deemed to be unnecessary. In some embodiments the steps described with reference to FIGS. 24 and 25 correspond to steps described in FIG. 5 as follows:

| FIGS. 24-25 | FIG. 5 |
|---|---|
| 2405 | 510 |
| 2410 | 525 |
| 2415 | 535 |
| 2420 | 536 |
| 2425 | 537 |
| 2430 | 540 |
| 2435 | 555 |
| 2440 | 561 |
| 2445 | 562 |
| 2450 | 565-567 |
| 2455 | 573-574 |

Benefits

The embodiments described herein resolve security issues for the download of a client certificate to an unsecured client device and also secure the storage and usage of the private key.

The client certificates and private keys are loaded into a client secure device in a secure environment. Therefore all the certificates and private keys are protected securely in the client secure device.

Normally the client secure application has to register with the client secure device before it can connect to any other communication device. It is convenient for the client secure application to provision the client certificate and private key from the client secure device using the client LAN. This doesn't require the client device to have an Internet connection to become provisioned from an Internet server. However, the secure device can be a device over the Internet.

The client private key is downloaded and stored by the client secure application rather than an OS or platform code of the client device. This helps prevent other unsecured applications from using this private key. This also allows a third party software provider which doesn't control OS and platform code on client devices to implement client certificate and private key download.

The two-way authentication between the client secure application and the client secure device, and the client private key and certificate verification in the protocol prevents illegal applications from acquiring the private key and the certificate and also prevents the secure client application from being given a private key and certificate by a fake secure device.

The protocol design securely verifies the client using the client's embedded private key and exchanges the session key. The Bootstrap Private key embedded into the client application helps to authenticate the client application as a legitimate application. Also the Bootstrap Private key is protected by the 3^{rd} party obfuscation technology that can be trusted by the industry.

The secret data are processed by the protocol and obfuscation techniques in a secure way so that no vital data is exposed in the memory of the client device.

Re-encrypting the client private key using a NLK prevents the client private key from being cloned in another client device.

The client certificates are issued with one or more special sub-CA's (Certificate Authorities). In case the Bootstrap private key that is embedded inside the client secure application is compromised on a particular class of devices (e.g., a particular brand of mobile devices), all the client secure applications that are affected can be revoked by just revoke the sub-CA certificate that is associated with that class of devices. Different classes of devices may have their own separate sub-CA certificate as well as their own Bootstrap private key.

Comprehensive Statements

It should be apparent to those of ordinary skill in the art that for the methods described herein other steps may be added or existing steps may be removed, modified or rearranged without departing from the scope of the methods. Also, the methods are described with respect to the apparatuses described herein by way of example and not limitation, and the methods may be used in other systems.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

The processes illustrated in this document, for example (but not limited to) the method steps described in FIGS. 2, 4-18, 20-23, and 24, may be performed using programmed instructions contained on a computer readable medium which may be read by processor of a CPU. A computer readable medium may be any tangible medium capable of storing instructions to be performed by a microprocessor. The medium may be one of or include one or more of a CD disc, DVD disc, magnetic or optical disc, tape, and silicon based removable or non-removable memory. The programming instructions may also be carried in the form of packetized or non-packetized wireline or wireless transmission signals.

It will be appreciated that some embodiments may comprise one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or apparatuses described herein. Alternatively, some, most, or all of these functions could be implemented by a state machine that has no stored program instructions, or in one or more application specific integrated circuits (ASICs), in which each function or some combinations of certain of the functions are implemented as custom logic. Of course, a combination of the approaches could be used.

Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

In the foregoing specification, specific embodiments have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method used in a secure device having secure storage, comprising:
receiving from a secure server over a secure connection a secure device certificate, a secure device private key, and a plurality of client device certificates, wherein each client certificate is not assigned to any particular client device;
receiving from the secure server over the secure connection a plurality of encrypted client private keys, wherein each of the encrypted client private keys comprises a client private key associated with one of the client device certificates key-encrypted with a bootstrap public key;
storing the plurality of client device certificates;
storing the plurality of encrypted client private keys in protected form; and
transferring an assigned client device certificate and an associated encrypted client private key to a client device that successfully registers with the secure device using an identification of the bootstrap public key.

2. The method according to claim 1, wherein the step of storing the plurality of encrypted client private keys in protected form comprises double encrypting each of the plurality of encrypted client private keys with an external storage key.

3. The method according to claim 1, wherein transferring comprises:
receiving a first message comprising a client device identification, a client group bootstrap public key identification, and a client device random nonce from the secure application running in the client device;
verifying that the public key identification is supported;
sending a second message to the secure application that comprises an encrypted secure device random nonce and a secure device certificate, wherein the encrypted secure device nonce has been encrypted with a client group bootstrap public key that is identified by the client group bootstrap identification;
deriving a session encryption key from the client device random nonce and the secure device random nonce;
deriving a session authentication key from the client device random nonce and the secure device random nonce;
receiving a third message from the secure application with a signature computed using the session authentication key;
authenticating the third message using the session authentication key;
assigning an unassigned one of the plurality of client certificates to the client device; and
sending a fourth message to the secure application comprising the assigned client certificate and the associated encrypted client private key, wherein the fourth message is signed with a signature computed using the session authentication key.

4. The method according to claim 3, wherein sending the fourth message comprises:
retrieving and decrypting a double encrypted client private key version of an encrypted client private key associated with the assigned client device using the external storage key; and
encrypting the encrypted client private key with the session encryption key.

5. The method according to claim 3, wherein the derivation of the session encryption key uses an AES encrypt function and an XOR function with a first hardcoded constant, wherein the derivation of the session authentication key uses an AES encrypt function and an XOR function with a second hardcoded constant, and wherein the signature of each of the third and fourth message is an AES-CMAC signature.

6. The method according to claim 1, wherein each of the key-encrypted client private keys comprises a concatenation of an encryption of the private exponent of the client private key by a random number uniquely associated with the client private key and an encryption of the random number by the bootstrap public key.

7. A method used by a secure application running in a client device for secure certificate provisioning of the secure application, comprising:
sending a first message comprising a client device identification, a client group bootstrap public key identification, and a client device random nonce to another client device that is a secure device;
receiving a second message from the secure device that comprises an encrypted secure device random nonce and a secure device certificate, wherein the encrypted secure device nonce has been encrypted with a bootstrap public key identified by the client bootstrap identification;
decrypting the encrypted secure device random nonce using the bootstrap public key and a white box decryption function to produce a transformed secure device random nonce;
deriving a session authentication key from the random client device nonce and the transformed secure device random nonce;
deriving a session encryption key from the random client device nonce and the transformed secure device random nonce;
sending a third message to the secure device with a signature computed using the session authentication key;
receiving a fourth message from the secure device comprising a client certificate that is assigned to the client device and an associated double encrypted client private key, wherein the fourth message is signed with a signature computed using the session authentication key;
authenticating the signed fourth message using the session authentication key;
storing the device certificate in persistent memory of the client device;
generating a client private key by decrypting the double encrypted client private key using the session key and the bootstrap public key; and
re-encrypting the client private key with a node locking key based on hardware specific information of the client device and persistently storing the re-encrypted client private key in persistent memory of the client device, wherein the secure device random nonce and the client private key are never stored in persistent memory of the client device.

8. The method according to claim 7, wherein the derivation of the session encryption key uses an AES encrypt function and an XOR function with a first hardcoded constant, wherein the derivation of the session authentication key uses an AES encrypt function and an XOR function with a second hardcoded constant, and wherein the signature of each of the third and fourth message is an AES-CMAC signature.

9. The method according to claim 7, wherein the double encrypted client private key comprises a concatenation of an encryption of the client private key by a random number uniquely associated with the client private key and an encryption of the random number by the bootstrap public key, wherein the concatenation is further encrypted with the session key.

10. A secure device, comprising:
an I/O function that receives from a secure server over a secure connection a secure device certificate, a secure device private key, and a plurality of client device certificates, wherein each client certificate is not assigned to any particular client device, and
receives from the secure server over the secure connection a plurality of encrypted client private keys, wherein each of the encrypted client private keys comprises a client private key associated with one of the client device certificates key-encrypted with a bootstrap public key;
a memory that persistently stores the plurality of client device certificates;
a security function that persistently stores the plurality of encrypted client private keys in the memory in protected form; and
a processing system that assigns a client device certificate and the associated client private key to a client device that successfully registers with the secure device in which a secure application runs that registers with the secure device, and
transfers the assigned client device certificate and the associated client private key to a client device using the I/O function and the security function.

11. The secure device according to claim 10, wherein the security function performs double encrypting each of the plurality of key-encrypted client private keys with an external storage key.

12. The secure device according to claim 10, wherein transferring comprises:
receiving by the I/O function a first message comprising a client device identification, a client group bootstrap public key identification, and a client device random nonce from the secure application running in the client device;
verifying by the processing system that the public key identification is supported;
sending by the I/O function a second message to the secure application that comprises an encrypted secure device random nonce and a secure device certificate, wherein the encrypted secure device nonce has been encrypted with a client group bootstrap public key that is identified by the client group bootstrap identification;
deriving by the security function a session encryption key from the client device random nonce and the secure device random nonce;
deriving by the security function a session authentication key from the client device random nonce and the secure device random nonce;
receiving by the I/O function a third message from the secure application with a signature computed using the session authentication key;
authenticating by the security function the third message using the session authentication key;
assigning by the processing function an unassigned one of the plurality of client certificates to the client device;
sending a fourth message by the I/O function to the secure application comprising the assigned client certificate and the associated encrypted client private key, wherein the fourth message is signed with a signature computed using the session authentication key.

13. The secure device according to claim 12, wherein sending the fourth message comprises:
retrieving and decrypting by the security function a double encrypted client private key version of an encrypted client private key associated with the assigned client device using the external storage key; and
encrypting by the security function the encrypted client private key with the session encryption key.

14. The secure device according to claim 12, wherein the derivation of the session encryption key uses an AES encrypt function and an XOR function with a first hardcoded constant, wherein the derivation of the session authentication key uses an AES encrypt function and an XOR function with a second hardcoded constant, and wherein the signature of each of the third and fourth message is an AES-CMAC signature.

15. The secure device according to claim 12, wherein each of the key-encrypted client private keys comprises a concatenation of an encryption of the private exponent of the client private key by a random number uniquely associated with the client private key and an encryption of the random number by the bootstrap public key.

16. A client device, the device comprising:
an I/O function that provides two way communications with a secure device, wherein the I/O function is under control of a processing system executing a secure application, and wherein the I/O function
sends a first message comprising a client device identification, a client group bootstrap public key identification, and a client device random nonce to another client device that is a secure device, and
receives a second message from the secure device that comprises an encrypted secure device random nonce and a secure device certificate, wherein the encrypted secure device nonce has been encrypted with a bootstrap public key identified by the client bootstrap identification;
the processing system executing the secure application further decrypts the encrypted secure device random nonce using the bootstrap public key and a white box decryption function to produce a transformed secure device random nonce,
derives a session authentication key from the random client device nonce and the transformed secure device random nonce, and
derives a session encryption key from the random client device nonce and the transformed secure device random nonce;
the I/O function under control of a processing system executing a secure application further
sends a third message to the secure device with a signature computed using the session authentication key, and
receives a fourth message from the secure device comprising a client certificate that is assigned to the client device and an associated double encrypted client private key, wherein the fourth message is signed with a signature computed using the session authentication key;
the processing system executing the secure application further authenticates the signed fourth message using the session authentication key,
stores the device certificate in a memory of the client device,
generates a client private key by decrypting the double encrypted client private key using the session key and the bootstrap public key, and
re-encrypts the client private key with a node locking key based on hardware specific information of the client device; and
a memory in which the re-encrypted client private key is persistently stored by the processing system executing the secure application.

17. The client device according to claim 16, wherein the derivation of the session encryption key uses an AES encrypt function and an XOR function with a first hardcoded constant, wherein the derivation of the session authentication key uses an AES encrypt function and an XOR function with a second hardcoded constant, and wherein the signature of each of the third and fourth message is an AES-CMAC signature.

18. The client device according to claim 16, wherein the double encrypted client private key comprises a concatenation of an encryption of the private exponent of the client private key by a random number uniquely associated with the client private key and an encryption of the random number by the bootstrap public key, and wherein the concatenation is further encrypted with the session key.
